(19) United States
(12) Patent Application Publication
(10) Pub. No.: US 2007/0257777 A1
(43) Pub. Date: Nov. 8, 2007

(54) Method and apparatus for detecting device change in wireless network environment

(75) Inventors: Jae-kwon Kim, Suwon-si (KR); Seong-soo Kim, Gangdong-gu (KR); Hee-yong Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/651,065

(22) Filed: Jan. 9, 2007

(30) Foreign Application Priority Data
May 3, 2006 (KR) 10-2006-0040043

(51) Int. Cl. G06F 7/02

(52) U.S. Cl. 340/146.2

(57) ABSTRACT

A method and apparatus are provided for detecting a device change in a wireless network environment. The method includes receiving change information of a change device transmitted through a first channel, which is different from a second channel used by a plurality of devices, which form a wireless network, to transmit or receive data; storing the received change information; and reconfiguring the wireless network using the stored change information.

### CROSS-REFERENCE TO RELATED APPLICATION

This application is based on and claims priority from Korean Patent Application No. 10-2006-0040043 filed on May 3, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to a wireless network. More particularly, the present invention relates to detecting a device change in a wireless network environment.

2. Description of the Related Art

A wireless transmission method is classified into an omni-directional wireless transmission method and a directional wireless transmission method according to directionality of radio wirelessly transmitted over a wireless network.

FIGS. 1 and 2 illustrate a wireless home network system using an omni-directional wireless transmission method.

Specifically, FIG. 1 illustrates a case where a first wireless device 111 transmits a data packet in a wireless home network 110. Referring to FIG. 1, the first wireless device 111 transmits the data packet not in a particular direction, but in all directions. Accordingly, a second wireless device 112 and a third wireless device 113 receive or perceive the data packet.

FIG. 2 illustrates a case where a second wireless device 122 transmits a data packet in a wireless home network 120. Referring to FIG. 2, the second wireless device 122 transmits the data packet not in a particular direction, but in all directions. Accordingly, a first device 121 and a third device 123 receive or perceive the data packet.

If only one wireless channel is used in FIGS. 1 and 2, since a data packet is transmitted in all directions from a wireless device, the other wireless devices cannot transmit data using the same channel while the data packet is transmitted.

If a new wireless device is connected to a wireless network or if an existing wireless device is disconnected from the wireless network while data is being transmitted/received in the wireless network, the information regarding the connection of the new wireless device or the disconnection of the existing wireless device can be transmitted only when a wireless channel is not busy. That is, if the wireless channel is not busy, a wireless device transmits a packet related to device detection to all devices in a network domain, and devices that can receive the packet re-interpret the received packet.

Therefore, while a data packet is transmitted or received, that is, while a wireless channel is busy, it is not possible to update existing information in order to reflect information regarding the connection/disconnection of a wireless device. Consequently, the information regarding the connection/disconnection of the wireless device may be lost, or an operation of updating the existing information following the connection/disconnection of the wireless device has to be delayed until the wireless channel is not busy.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for quickly and efficiently detecting a change, such as connection or disconnection of a device, in a wireless network.

The present invention also provides a method and apparatus which can enhance network efficiency by preventing data transmission/reception from being interfered with by a change in the configuration of a wireless network.

However, the aspects of the present invention are not restricted to the ones set forth herein. The above and other aspects of the present invention will become more apparent to one of ordinary skill in the art to which exemplary embodiments of the present invention pertain by referencing a detailed description of exemplary embodiments of the present invention set forth below.

According to an aspect of the present invention, there is provided a method of detecting a device change in a wireless network environment. The method includes receiving change information of a change device transmitted through a first channel, which is distinguished from a second channel used by a plurality of devices, which form a wireless network, to transmit or receive data; storing the received change information; and reconfiguring the wireless network using the stored change information.

According to another aspect of the present invention, there is provided an apparatus for detecting a device change in a wireless network environment. The apparatus includes a main channel communication unit transmitting or receiving data to/from a plurality of devices, which form a wireless network, using a second channel; a back channel perception unit receiving change information of a change device transmitted through a first channel, which is distinguished from the second channel; a change information storage unit storing the received change information; and a wireless network configuration unit reconfiguring the wireless network using the stored change information.

### BRIEF DESCRIPTION OF THE DRAWINGS

The above and other aspects of the present invention will become more apparent by describing in detail exemplary embodiments thereof with reference to the attached drawings, in which:

FIGS. 1 and 2 illustrate a wireless home network system using an omni-directional wireless transmission method;

FIG. 3 illustrates a directional wireless transmission method according to an exemplary embodiment of the present invention;

FIG. 4 illustrates device detection in a wireless network according to an exemplary embodiment of the present invention;

FIG. 5 illustrates device detection in a wireless network according to another exemplary embodiment of the present invention;

FIGS. 6 and 7 illustrate the configurations of main and back channels according to an exemplary embodiment of the present invention;

FIG. 8 is a flowchart illustrating a case in which a device is connected to a wireless network managed by a master device according to an exemplary embodiment of the present invention;

FIG. 9 is a flowchart illustrating a method of informing of the disconnection of a wireless device through a back channel according to an exemplary embodiment of the present invention; and

FIG. 10 is a block diagram of a master device according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the exemplary embodiments of the invention to those skilled in the art. Like reference numerals in the drawings denote like elements, and thus their description will be omitted.

Hereinafter, a method and apparatus for detecting a device change in a wireless network environment according to exemplary embodiments of the present invention will be described with reference to block diagrams or flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

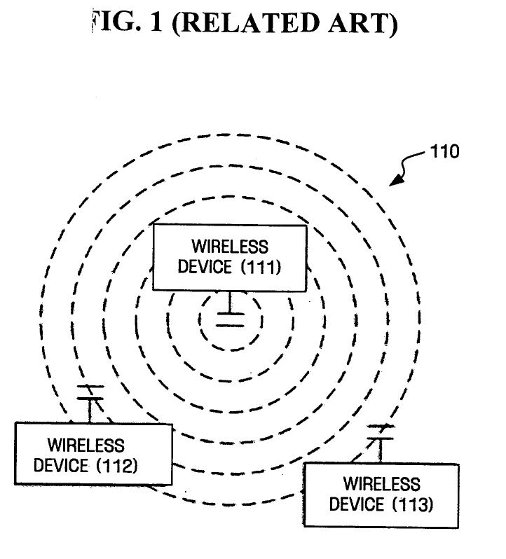

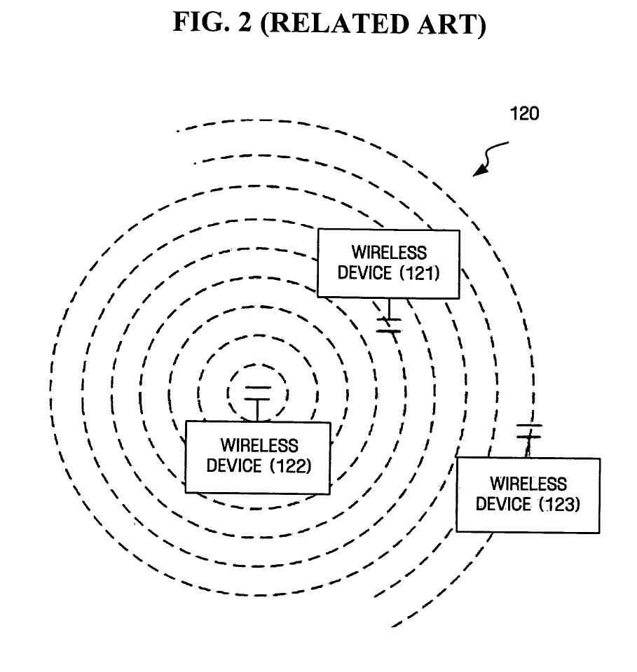

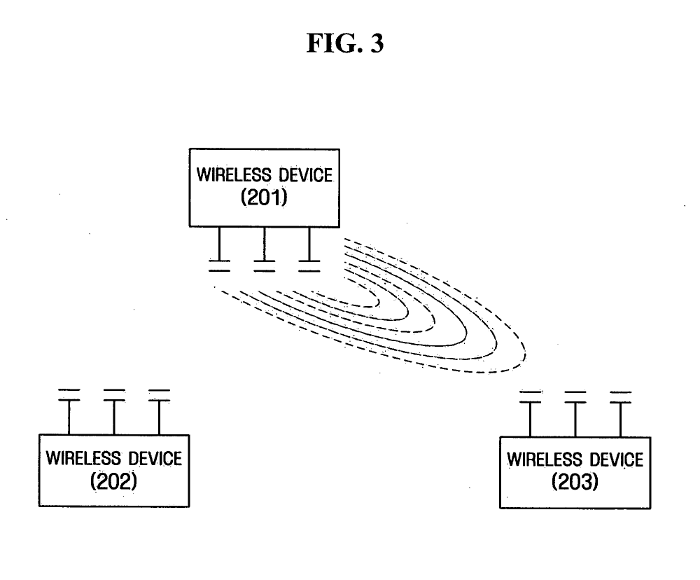

FIG. 3 illustrates a directional wireless transmission method according to an exemplary embodiment of the present invention. Referring to FIG. 3, a first wireless device 201 transmits a data packet to a third wireless device 203. Unlike in the omni-directional wireless transmission method illustrated in FIG. 1 or 2, a second device 202 cannot perceive the data packet transmitted between the first wireless device 201 and the third wireless device 203 in the directional wireless transmission method illustrated in FIG. 3. Therefore, the second wireless device 202 can transmit or perceive data through the same channel used by the first wireless device 201 and the third wireless device 203 to transmit the data packet. In connection, the first wireless device 201 can receive a data packet transmitted from a different direction of the same channel. An exemplary embodiment of the directional wireless transmission method illustrated in FIG. 3 is a millimeter wave (mmWave) which uses a frequency band of 60 GHz and transmits high-quality audio/video (AV) data without compression. If data is transmitted omni-directionally using mmWave, a distance traveled by a beam is short. Therefore, it is not easy to use mmWave as a wireless personal area network (PAN). Hence, the beam is transmitted directionally.

In this specification, a wireless device and a device are considered the same, and the wireless device denotes a device that can transmit or receive data over a wireless network.

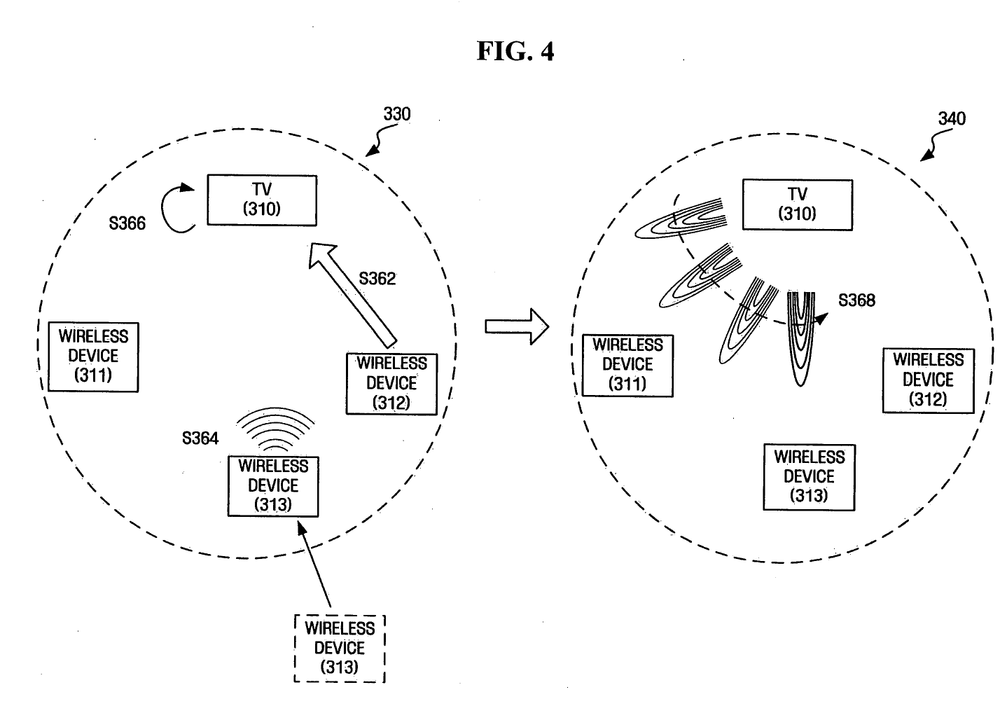

FIG. 4 illustrates device detection in a wireless network according to an exemplary embodiment of the present invention.

In an exemplary embodiment of the present embodiment, a wireless home network is configured based on a television (TV).

Referring to FIG. 4, a TV 310 manages a plurality of wireless devices in a wireless network 330. Currently, the TV 310 is receiving data from a second wireless device 312 (operation S362). Data received through a main channel may be audio or video data. While the TV 310 is wirelessly receiving the data, a third wireless device 313 is newly added to the wireless network 330 (operation S364). The third wireless device 313 transmits to the TV 310 information regarding its connection to the wireless network 330 using a back channel and an omni-directional transmission method (operation S364). The TV 310 stores the information received through the back channel. In an exemplary embodiment of a method of storing the information, the TV 310 may set a flag informing of the connection of a new device or the disconnection of an existing device.

After setting information that records the connection of a new device or the disconnection of an existing device, such as flag setting, the TV 310 continues to transmit data to or receive data from the second wireless device 312 using the main channel. Upon completion of data transmission/reception or during the pause time of data transmission/reception, the TV 310 transmits a device detection packet within a range of 360 degrees or within a range in which the added third wireless device 313 can exist using the main channel and the directional transmission method as shown in a wireless network 340. The device detection packet includes identifier or identification information of the added third wireless device 313. Wireless devices, which receive the device detection packet, may determine whether the received device detection packet is related to themselves and abandon or respond to the received device detection packet based on the determination result. For example, the first wireless device 311 receives the device detection packet transmitted by the TV 310 to detect the third wireless device 313. However, the first wireless device 311 may abandon the received device detection packet since the received device detection packet is not related to the first wireless device 311.

In the wireless home network configured as illustrated in FIG. 4, the first through third wireless devices 311 through 313 may be slave devices, and the TV 310 may be a master device.

In other words, a protocol of mmWave, which is an exemplary embodiment of a wireless network according to the present invention, may be applied to the operations illustrated in FIG. 4. In this case, while the second wireless device 312 is transmitting high-quality, uncompressed AV data to the TV 310 using directional mmWave, if the third wireless device 313 is added or removed to/from a home network domain, i.e., the wireless network 330, the added or removed third wireless device 313 may broadcast a packet, which informs the TV 310, i.e., the master device, of its connection or disconnection, using the omni-directional back channel.

Since the TV 310 is receiving the uncompressed AV data through the main channel, even if the TV 310 perceives the connection/disconnection of the third wireless device 313 based on the packet received through the back channel, it does not process the received packet. Instead, the TV 310 sets a flag of a register related to device connection/disconnection. Once the master device, i.e., the TV 310, finishes using the main channel, it identifies the flag related to device connection/disconnection and operates in a search mode of the main channel (that is, transmits a device detection packet while rotating 360 degrees and changing a directional beam at regular angle intervals).

The devices excluding the master device, that is, the slave devices, receive the device detection packet transmitted from the master device and transmit their own device information to the master device using the back channel or the main channel.

The master device perceives the position of each slave device based on a device detection response signal transmitted from each slave device and reconfigures a home network system.

The device detection packet transmitted from the master device includes angle information, and each slave device also transmits the angle information when responding to the master device so that the master device can determine the position of each slave device based on the received angle information.

If a device is removed before transmitting to the master device a packet informing of its disconnection, the master device can identify the disconnection of the device when the master device tries to use the removed device or when a new device is added to the home network domain and perform a device search method using the search mode.

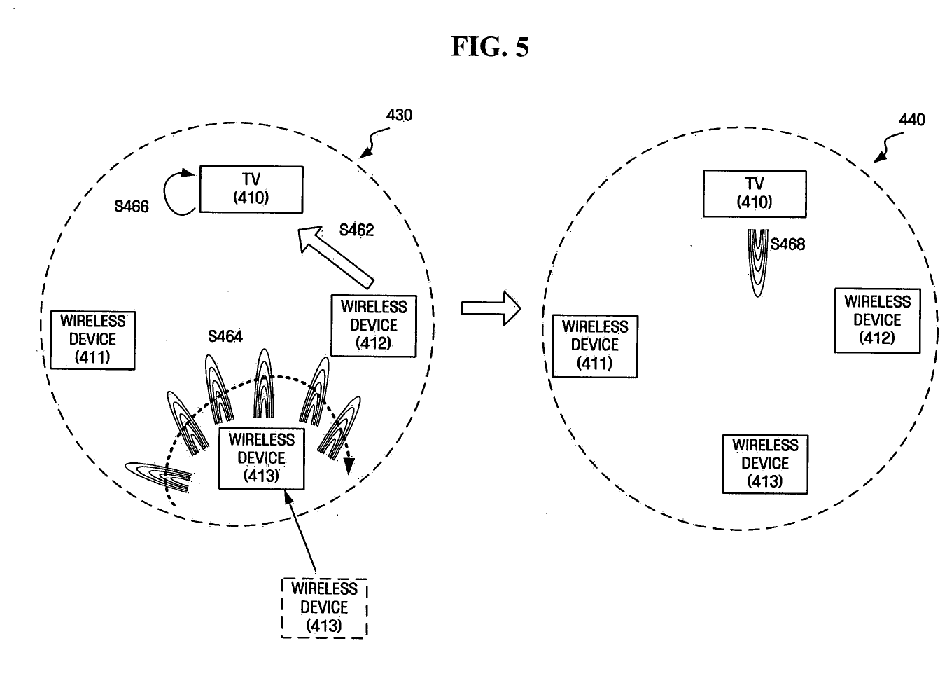

FIG. 5 illustrates device detection in a wireless network according to another exemplary embodiment of the present invention. As in FIG. 4, a wireless home network is configured based on a TV.

Referring to FIG. 5, a TV 410 manages a plurality of wireless devices in a wireless network 430. Currently, the TV 410 is receiving data from a second wireless device 412 (operation S462). Data received through a main channel may be audio or video data. While the TV 410 is wirelessly receiving the data, a third wireless device 413 is newly added to the wireless network 430 (operation S464). The third wireless device 413 transmits to the TV 410 information regarding its connection to the wireless network 430 using a back channel and a directional transmission method (operation S464). Here, since the third wireless device 413 does not know the position of the TV 410, it transmits the information while rotating 360 degrees.

The TV 410 stores the information received through the back channel (operation S466). In an exemplary embodiment of the method of storing the information, the TV 410 may set a flag informing of the connection of a new device or the disconnection of an existing device. Since the third wireless device 413 has transmitted to the TV 410 the information regarding its connection to the wireless network 430 using the directional transmission method, the TV 410 also stores position information of the third wireless device 413.

After setting information that records the connection of a new device or the disconnection of an existing device, such as flag setting, the TV 410 continues to transmit or receive data to/from the second wireless device 412 using the main channel. Upon completion of data transmission/reception or during the pause time of data transmission/reception, the TV 410 transmits a device detection packet to the third wireless device 413 using the main channel and the directional transmission method as shown in a wireless network 440. Since the TV 410 stored the position information of the third wireless device 413 in operation S466, the TV 410 may transmit the device detection packet to the third wireless device 413 using the directional transmission method, and the third wireless device 413 may respond to the device detection packet.

In other words, the protocol of mmWave, which is an exemplary embodiment of the wireless network according to the present invention, may be applied to the operations illustrated in FIG. 5. In this case, while the second wireless device 412 is transmitting high-quality, uncompressed AV data to a master device, i.e., the TV 410, using directional mmWave, if the third wireless device 413 is added or removed to/from a home network domain, i.e., the wireless network 430, the added or removed third wireless device 413 transmits a directional beam using the back channel at regular angle intervals over the whole range of 360 degrees.

Since the master device, i.e., the TV 410, is receiving the uncompressed AV data through the main channel, it perceives the connection of the third wireless device 413 based on a packet, i.e., the directional beam, received through the back channel, identifies the position of the added third wireless device 413 based on an angle and intensity of the received directional beam, and sets a flag of a register related to device connection.

Once the master device, i.e., the TV 410, finishes using the main channel, the master device identifies the flag related to device connection and transmits a transmits a directional beam through the main channel in a direction toward the position of the added third wireless device 413. A added slave device, i.e., the third wireless device 413, receives a device detection packet, i.e., the directional beam, from the master device and transmits its device information to the master device using the back channel or the main channel. The master device perceives the position of the added slave device based on a device detection response signal transmitted from the added slave device and reconfigures a home network system.

As described above, while a master device, such as a TV, is transmitting or receiving high-definition, uncompressed AV data using mmWave, if a slave device is removed from a home network domain, the slave device informs the master device of its disconnection through the back channel. After receiving or transmitting the AV data, the master device transmits a device detection packet in a direction toward the slave device and reconfigures a home network system based on a response from the slave device. If the slave device is removed without transmitting to the master device a packet informing of its disconnection, the master device may identify the disconnection of the slave device using the search mode when the master device tries to use the slave device or when a new slave device is added to the home network domain.

In FIG. 4 or 5, if a master device, such as a TV, is not transmitting or receiving data from/to another device through the main channel, the operations described above are sequentially performed.

In the configuration illustrated in FIG. 4 or 5, if a wireless device connected to a wireless network is removed, a master device, such as a TV, may update information regarding the wireless device when the wireless device is removed, when the master device tries to use the removed wireless device or when the master device searches for a new wireless device and may reconfigure the wireless network.

In connection, a wireless device may be removed without transmitting to the master a data packet informing of its disconnection because, for example, the wireless device is unexpectedly powered off. In this case, the master device may perceive the disconnection of the wireless device when trying to search for a new wireless device or when trying to exchange data with the removed wireless device.

When the master device receives response packets to a device detection packet that it transmitted to existing devices in order to check their existence while searching for a new device, the master device can identify which of the existing devices has been removed since it stores position information of the existing devices.

The main channel and the back channel illustrated in FIGS. 4 and 5 may be configured variously.

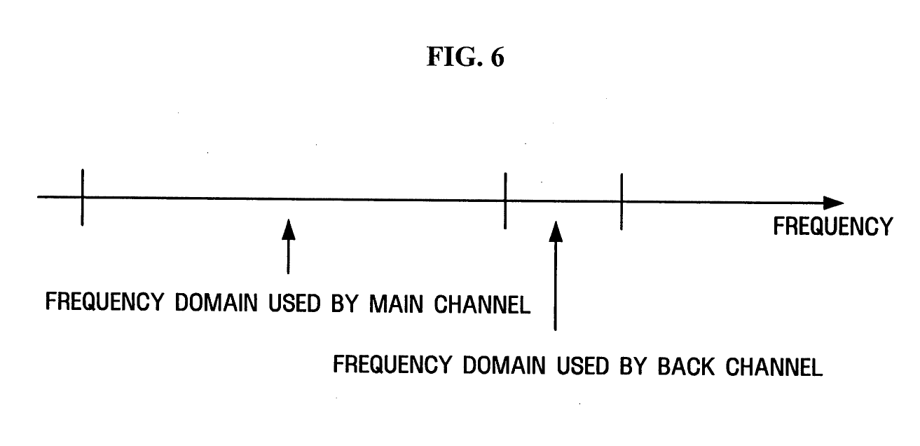

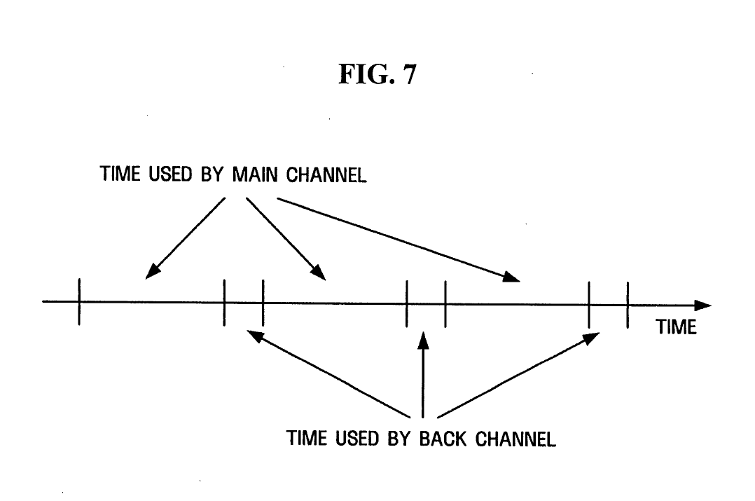

FIGS. 6 and 7 illustrate the configurations of main and back channels according to an exemplary embodiment of the present invention.

Specifically, FIG. 6 illustrates a case where the main and back channels use different frequency domains according to an exemplary embodiment of the present invention. Since the main channel and the back channel use different frequency bands, data transmission/reception in the main channel may not interfere or collide with data transmission/reception in the back channel.

FIG. 7 illustrates a time sharing method according to an exemplary embodiment of the present invention. The time sharing method in which the main channel and the back channel use the same frequency but use different times in order to transmit/receive data may be used.

In this specification, mmWave is used as an exemplary embodiment which enables directional data transmission/reception. Generally, mmWave uses a bandwidth of 60 GHz, but the present invention is not limited thereto. Any bandwidth can be used as long as directional data transmission/reception can be performed.

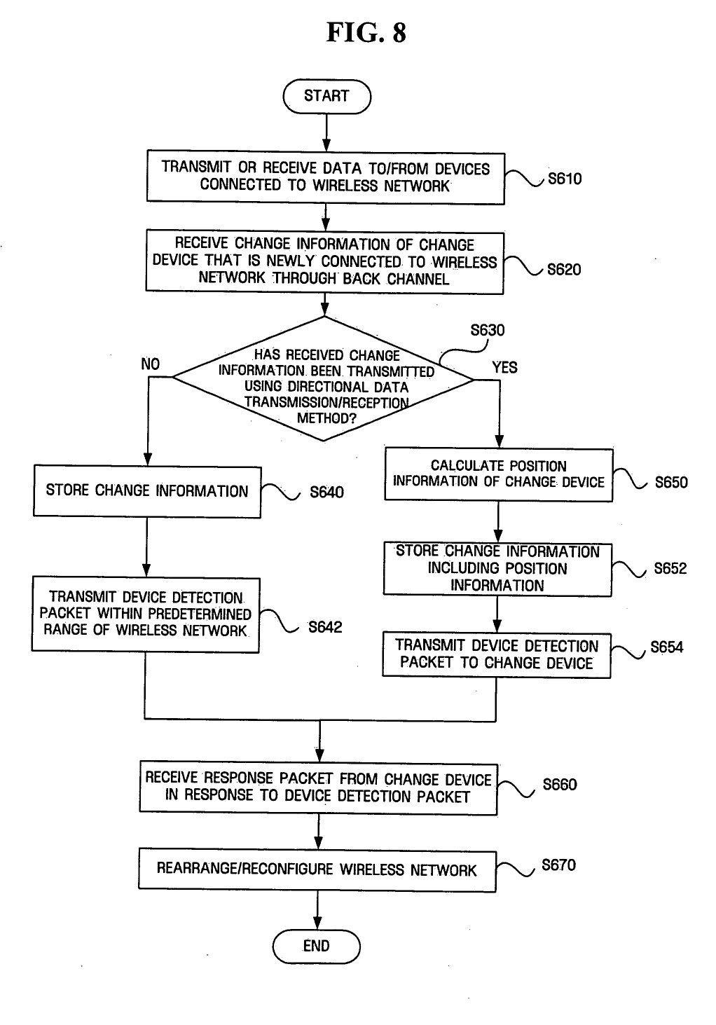

FIG. 8 is a flowchart illustrating a case where a device is connected to a wireless network managed by a master device according to an exemplary embodiment of the present invention. Hereinafter, a device newly added or removed to/from a wireless network will be referred to as a change device, and information regarding the connection or disconnection of the device will be referred to as change information. Referring to FIG. 8, a master device transmits or receives data to/from a device or a plurality of devices connected to the wireless network through a main channel (operation S610). The master device does not necessarily transmit or receive data to/from the device or the devices. However, the present exemplary embodiment is based on the assumption that the device or devices already connected to the wireless network is/are performing data transmission/reception when a new device is connected to the wireless network.

A change device newly connected to the wireless network transmits to the master device data, which includes change information indicating its participation in the wireless network, through a back channel, and the master device receives the data through the back channel (operation S620). Therefore, the data transmitted/received through the main channel is not lost or does not have a problem. The master device determines whether the received change information has been transmitted using a directional data transmission/reception method (operation S630).

If the change information has been transmitted using an omni-directional data transmission/reception method, the master device stores the change information (operation S640). Here, the master device stores the change information using the storage method described above with reference to FIG. 4. When data transmission/reception through the main channel is completed or temporarily stopped, since the master device can identify whether a new device has been connected to the wireless network based on the stored change information, the master device transmits a device detection packet within a predetermined range of the wireless network (operation S642). In this case, the master device transmits the device detection packet using the directional data transmission method. The predetermined range indicates a 360-degree range in which the master device transmits the device detection packet at regular angle intervals in order to detect the newly connected or added change device. If the master device is placed near a closed area, such as an area with walls, the master device may transmit the device detection packet within the range of 180 degrees in which other devices can exist.

If the connected change device receives the device detection packet, it transmits to the master device a response packet including its detailed information so that the master device can identify the connection of the new device to the wireless network. Accordingly, the master device receives the response packet transmitted by the change device in response to the device detection packet (operation S660). Then, the master device rearranges or reconfigures the wireless network, reflecting the connection of the change device to the wireless network (operation S670). Depending on the configuration or protocol of the wireless network, the master device may transmit to the other devices a packet informing that a new device has been added to the wireless network.

If it is determined in operation S630 that the change information has been transmitted using the directional data transmission method, the method illustrated in FIG. 5 may be implemented. In other words, since the connected change device transmits data using the directional transmission method through the back channel, the master device can identify a direction in which the change device exists when receiving the data. Therefore, the master device calculates position information of the change device (operation S650) and stores the change information including the calculated position information (operation S652).

When data transmission/reception through the main channel is completed or temporarily stopped, since the master device can identify whether a new device has been connected to the wireless network based on the stored change information, the master device transmits a device detection packet to the change device located at a position of the wireless network using the calculated position information which is included in the stored change information (operation S654). Here, the master device transmits the device detection packet using the directional data transmission method. Unlike in operation S642, since the master device can calculate the position of the change in operation S654, it can transmit the device detection packet to the calculated position. Subsequent operations, such as receiving a response packet transmitted by the change device in response to the device detection packet, are identical to operations S660 and S670 described above.

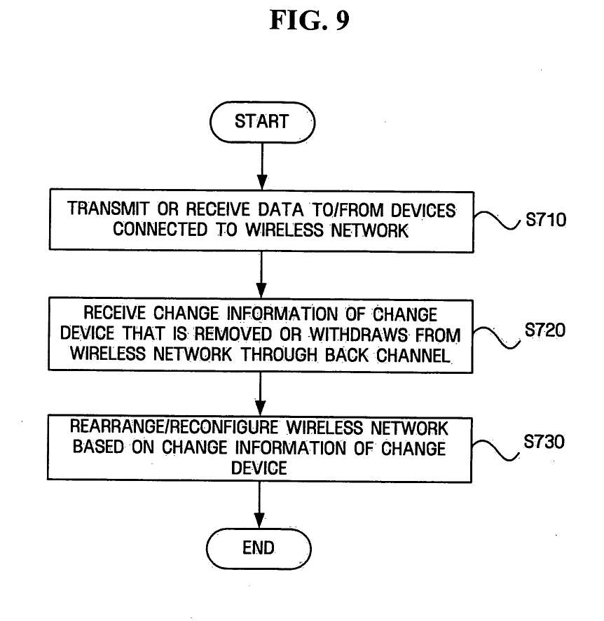

FIG. 9 is a flowchart illustrating a method of informing of the disconnection of a wireless device through a back channel according to an exemplary embodiment of the present invention.

Referring to FIG. 9, a master device transmits or receives data to/from a device or a plurality of devices connected to a wireless network through a main channel (operation S710). The master does not necessarily transmit or receive data to/from the device or the devices. However, an exemplary embodiment of the present invention is based on the assumption that the device or devices already connected to the wireless network is/are performing data transmission/reception when a device is removed or withdraws from the wireless network. The master device receives change information of a change device, which is removed or withdraws from the wireless network, through a back channel (operation S720). The back channel is distinguished from the main channel. The master device obtains information regarding the change device, such as position information, when the change device is connected to the wireless network. Therefore, unlike in the connection process, the master device omits an operation of transmitting a device detection packet and rearranges or reconfigures the wireless network based on the change information of the change device (operation S730).

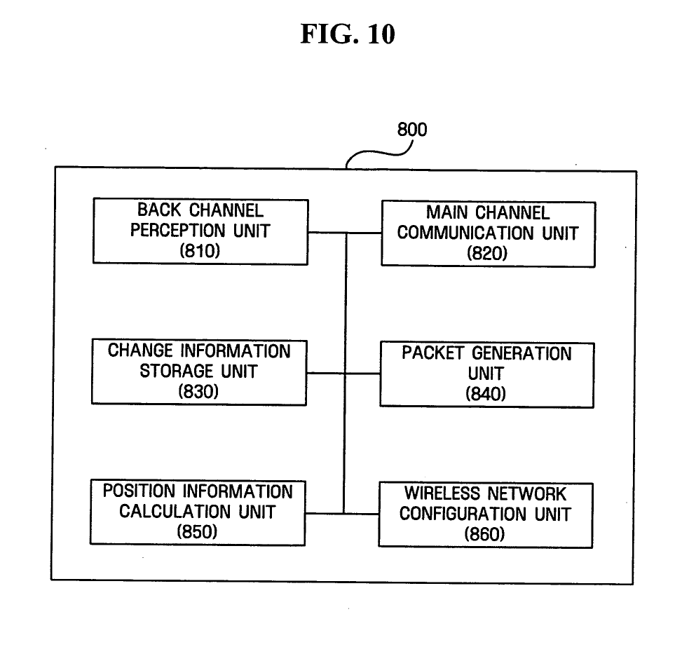

FIG. 10 is a block diagram of a master device 800 according to an exemplary embodiment of the present invention.

Each component means, but is not limited to, a software or hardware component, such as a Field Programmable Gate Array (FPGA) or Application Specific Integrated Circuit (ASIC). A component may advantageously be configured to reside on the addressable storage medium and configured to execute on one or more processors. The functionality provided for in the components may be combined into fewer components or further separated into connectional components. In connection, the components may be implemented to execute one or more computers in a system.

Referring to FIG. 10, the master device 800 can wirelessly transmit or receive data using main and back channels. A main channel communication unit 820 enables the master device 800 to transmit or receive data to/from other wireless devices. A back channel perception unit 810 perceives data received through the back channel, which is distinguished from the main channel. Transmitting data through the back channel may selectively be applicable. If the back channel perception unit 810 implements the method illustrated in FIG. 4, it receives change information (indicating connection of a new wireless device) transmitted using an omni-directional transmission method. In this case, the back channel perception unit 810 cannot identify position information of the newly added device (change device). On the other hand, if the back channel perception unit 810 implements the method illustrated in FIG. 5, it receives change information (indicating connection of a new device) transmitted using a directional transmission method. In this case, the back channel perception unit 810 can identify position information of the newly added device (change device).

A change information storage unit 830 stores change information perceived or received by the back channel perception unit 810. The change information storage unit 830 stores the change information before a wireless network is reconfigured following the connection of the new wireless device. The change information storage unit 830 may store the change information using a flag setting method or a change database update method.

If data transmission/reception of the main channel communication unit 820 is completed or stopped, a packet generation unit 840 of the master device 800 generates a device detection packet with reference to the change information stored in the change information storage unit 830 in order to identify information regarding the new wireless device. The device detection packet generated by the packet generation unit 840 is transmitted through the main channel communication unit 820. As illustrated in FIGS. 4 and 5, the device detection packet used to detect the newly added device may be transmitted in various directions (FIG. 4) or in a direction in which the added device exists (FIG. 5). The method of transmitting the device detection packet may depend on which of the methods illustrated in FIGS. 4 and 5 is implemented or on a wireless transmission method supported by the newly added device.

A wireless network configuration unit 860 rearranges or reconfigures the wireless network so that the master device 800 can include the newly added device in the wireless network based on a response of the newly added device to the device detection packet. The wireless network configuration unit 860 may also rearrange the wireless network to reflect the disconnection of a device according to the flowchart of FIG. 9.

A position information calculation unit 850 calculates position information of the newly added wireless device. In the case of FIG. 4, the position information calculation unit 850 may analyze a response packet transmitted by the newly added device in response to the device detection packet and calculate the position information of the newly added device. In the case of FIG. 5, the position information calculation unit 850 may analyze a data packet which includes change information received through the back channel and calculate the position of the newly added device.

Since the master device 800 is a device that manages a wireless network, it may perform various functions other than those illustrated in FIG. 10 in order to manage the wireless network.

The back channel perception unit 810, the change information storage unit 830, the position information calculation unit 850, or the wireless network configuration unit 860 is not an essential component of a wireless device which functions as a slave device. Therefore, a slave device may not include the above components as long as it can wirelessly exchange data with the master device 800.

In addition, the slave device may transmit data to the master device 800 using the directional or omni-directional transmission method according to the functionality thereof.

According to an exemplary embodiment of the present invention, a device newly added or removed to/from a wireless network can be quickly discovered.

According to an exemplary embodiment of the present invention, ongoing data transmission/reception is not interfered with by a change in the configuration of a wireless network. Therefore, network efficiency can be enhanced.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the following claims, and all differences within the scope will be construed as being included in the present invention.

What is claimed is:

1. A method of detecting a device change in a wireless network environment, the method comprising:
receiving change information of a change device transmitted through a first channel, which is different from a second channel used by a plurality of devices, which form the wireless network, to transmit or receive data;
storing the received change information; and
reconfiguring the wireless network using the stored change information.

2. The method of claim 1, further comprising:
transmitting a detection packet to the change device after the storing the received change information; and
receiving a response packet from the change device in response to the detection packet.

3. The method of claim 2, wherein the change information comprises information regarding the change device, which is included in the response packet, or position information of the change device calculated after the response packet is received.

4. The method of claim 2, wherein the transmitting the detection packet comprises transmitting the detection packet transmitted using a directional data transmission or reception method.

5. The method of claim 1, wherein the change device is a device which is added to or removed from the wireless network.

6. The method of claim 1, further comprising calculating the position information of the change device after the receiving the change information if a data transmission method using the first channel is a directional data transmission method.

7. The method of claim 1, further comprising, after the reconfiguring the wireless network, transmitting a packet for identifying changes in the devices, which form the wireless network, based on position information of the devices.

8. The method of claim 1, wherein the change information comprises information indicating one of connection of the change device to the wireless network and disconnection of the change device from the wireless network.

9. The method of claim 1, wherein the data is one of transmitted and received through the second channel using a directional data transmission or reception method.

10. An apparatus for detecting a device change in a wireless network environment, the apparatus comprising:
a main channel communication unit which is communicably linked to a plurality of devices, which form a wireless network, via a second channel;
a back channel perception unit which receives change information of a change device transmitted through a first channel, which is different from the second channel;
a change information storage unit which stores the received change information; and
a wireless network configuration unit which reconfigures the wireless network using the stored change information.

11. The apparatus of claim 10, further comprising a packet generation unit which generates a detection packet that is to be transmitted to the change device, wherein one of the main channel communication unit and the back channel perception unit transmits the generated detection packet and receives a response packet from the change device in response to the detection packet.

12. The apparatus of claim 11, wherein the change information comprises one of information regarding the change device, which is included in the response packet, and position information of the change device calculated after the response packet is received.

13. The apparatus of claim 11, wherein the main channel communication unit transmits the detection packet using a directional data transmission or reception method.

14. The apparatus of claim 10, wherein the change device is a device which is added to or removed from the wireless network.

15. The apparatus of claim 10, further comprising a position information calculation unit which calculates position information of the change device.

16. The apparatus of claim 10, wherein the main channel communication unit transmits a packet for identifying changes in the plurality of devices, which form the wireless network, based on position information of the devices.

17. The apparatus of claim 10, wherein the change information comprises information indicating one of connection of the changed device to the wireless network and disconnection of the change device to/from the wireless network.

18. The apparatus of claim 10, wherein the data is one of transmitted and received through the second channel using the directional data transmission or reception method.
